(19) United States
(12) Patent Application Publication
(10) Pub. No.: US 2025/0364686 A1
(43) Pub. Date: Nov. 27, 2025

(54) METAL SEPARATOR AND METHOD FOR MANUFACTURING THE SAME

(71) Applicant: Hyundai Steel Company, Incheon (KR)

(72) Inventor: Won Seog Yang, Incheon (KR)

(21) Appl. No.: 19/287,307

(22) Filed: Jul. 31, 2025

Related U.S. Application Data
(63) Continuation of application No. PCT/KR2024/001543, filed on Feb. 1, 2024.

(30) Foreign Application Priority Data
Feb. 2, 2023 (KR) 10-2023-0014259

(51) Int. Cl. H01M 50/434; H01M 50/403; H01M 50/431; H01M 50/449; H01M 50/489

(52) U.S. Cl. CPC H01M 50/434; H01M 50/403; H01M 50/431; H01M 50/449; H01M 50/489

(57) ABSTRACT

In one aspect, a metal separator is provided that includes a metal base material; and a coating layer formed on a surface of the metal base material and containing a conductive filler and an inorganic polymer.

### CROSS-REFERENCE TO RELATED APPLICATIONS

This application is a continuation of International Application No. PCT/KR2024/001543 filed on Feb. 1, 2024, which claims under 35 U.S.C. § 119(a) the benefit of Korean Patent Application No. 10-2023-0014259 filed on Feb. 2, 2023, the entire contents of which applications are incorporated by reference herein.

### FIELD

The present disclosure relates to a metal separator and a method of manufacturing the same.

### BACKGROUND

In recent years, powertrains have been changing from internal combustion engines (ICEs) to electric vehicles (EVs) or hydrogen fuel cell electric vehicles (FCEVs) in order to deal with global warming. Fuel cells used in hydrogen fuel cell electric vehicles (FCEVs) not only supply power for industrial and household purposes and for driving vehicles, but also are used for power supply to small electronic products such as portable devices, and the scope of their use is gradually expanding as a highly efficient clean energy source in terms of both energy conservation and environmental measures.

A fuel cell is a kind of electric power generation device that converts the chemical energy held by fuel into electrical energy by electrochemically reacting it in a stack, and generates electricity by using the energy produced during the binding reaction of hydrogen and oxygen. Specifically, a fuel cell can use hydrogen gas as fuel, and the oxidation reaction of the hydrogen gas can occur and thus generate hydrogen ions (protons) and electrons. The hydrogen ions and electrons generated at this time cause an electrochemical reaction with oxygen in the air to produce water, and at the same time, electrical energy is generated from the flow of electrons.

Such a hydrogen fuel cell is composed of a membrane electrode assembly coated with a catalyst powder, a gas diffusion layer (GDL), and a separator. Hydrogen fuel cells can generate a voltage of 1.229 V in theory, but have an operating voltage of 0.6 V to 0.8 V due to various limiting conditions, such as the inherent characteristics of the above components and the characteristics between the components.

Of these components, the separator must play various roles such as structural support for the gas diffusion layer, collection and transfer of generated electric current, transport and removal of reaction gases, and transport of cooling water for removal of reaction heat, and should thus have properties such as excellent electrical conductivity, thermal conductivity, gas tightness, and chemical stability. That is, the separator must be ensured to have corrosion resistance because it is of a structure in which hydrogen ions inevitably dissolve in water and form acid, and at the same time, must have electrical conductivity because hydrogen and oxygen react to release electrons and the generated electrons must be transferred through the separator.

The U.S. Department of Energy (DOE), the center of environmental energy research, requires materials that can withstand a pH of 4 or higher as separators. In addition, actual corrosion tests are conducted in environments with a pH of 1 to 3 and 0.6 V_{vs SCE}. In order to secure corrosion resistance, materials in such environments must exhibit a current density of 10 μA/cm² or less at an electrokinetic potential of 0.6 V_{vs SCE} and an interface contact resistance of 20 mΩ·cm² or less under a pressure of 133 N/m. Furthermore, the materials are required to have an electrical conductivity of 100 S/cm² or more or a contact resistance of 20 mΩ·cm² or less.

Metal materials initially exhibit a high electrical conductivity of 10⁴ S/cm² or more. However, metal materials suffer from the issue of their electrical conductivity being decreased due to corrosion. Further, in the case of graphite, it is difficult to control the reduction of thickness with concern of crack occurrence and hydrogen permeability during processing, great care should be taken during the process, and there are limitations in securing weight reduction and economic feasibility.

Patent Document 1 (Korean Patent No. 0839193) reports use of a metal separator having a coating layer containing an organic binder and carbon particles formed on a base material made of a metal material. This metal separator was able to secure corrosion resistance, but caused the problem of lowering electrical conductivity by the organic binder.

The organic binder was removed to secure electrical conductivity, but the adhesion of the coating layer was greatly reduced due to the removal of the organic binder, resulting in a problem that the coating layer was easily removed even with low shear stress. Therefore, in order to solve these problems, there is a need for a metal separator having excellent electrical conductivity, corrosion resistance, and adhesion, and a method of manufacturing the same.

### SUMMARY

It is an object of the present disclosure to provide a metal separator having excellent electrical conductivity and corrosion resistance as well as excellent adhesion of a coating layer, and a method of manufacturing the same.

In one aspect, a metal separator of the present disclosure includes a metal base material; and a coating layer formed on a surface of the metal base material and containing a conductive filler and an inorganic polymer.

The conductive filler may include for example one or more selected from carbon black, carbon nanotubes, graphene, and carbon fibers.

In addition, the inorganic polymer may be for example a polymer containing a bond between a transition metal element of Group IVB and an oxygen atom. The inorganic polymer typically will be substantially or completely free of carbon, e.g. less than 10, 8, 6, 4, 5, 3, 2, 1, 0.5, or 0.25 weight percent of the polymer total weight will be carbon.

Further, the inorganic polymer may be for example contained in the coating layer at 0.01 to 50 parts by weight relative to 100 parts by weight of the conductive filler.

Moreover, the coating layer may have for example a thickness of 10 nm to 5000 nm.

Furthermore, the coating layer may have for example a contact resistance of 1 mΩ·cm² to 20 mΩ·cm².

In addition, the coating layer may have for example a corrosion current of 0.1 μA/cm² to 10 μA/cm².

Further, a method of manufacturing a metal separator of the present disclosure relates to a method of manufacturing a metal separator including a metal base material and a coating layer formed on a surface of the metal base material and containing a conductive filler and an inorganic polymer, and includes: a mixing step of mixing a conductive filler and an organic binder and producing a coating mixture; a coating step of coating the surface of the metal base material with the coating mixture, performing temporary drying, and forming a coating layer; a first heat treatment step of performing a first heat treatment on the temporarily dried coating layer and removing the organic binder in the coating layer; and a second heat treatment step of introducing a liquid metal-based organic substance into a region from which the organic binder has been removed, then performing a second heat treatment, and gelling the liquid metal-based organic substance into an inorganic polymer.

Moreover, the conductive filler may be for example contained in the coating mixture at 40 to 600 parts by weight relative to 100 parts by weight of the organic binder.

Furthermore, the temporary drying may be for example performed at a temperature of 80° C. to 200° C. for 10 seconds to 60 minutes.

Further, the first heat treatment may be for example performed at 250° C. to 900° C. for 10 seconds to 24 hours under a pressure of 0.05 Pa to 0.5 Pa.

In addition, the method of manufacturing a metal separator may further include a thickness adjustment step of the coating layer for reducing a thickness of the coating layer from which the organic binder has been removed.

Moreover, the liquid metal-based organic substance may be present in a state where a metal-based organic substance represented by Chemical Formula 1 below is dispersed in a liquid dispersion medium:

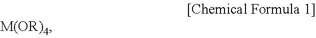

in Chemical Formula 1 above, M is a transition metal element of Group IVB, and R is a straight-chain or branched-chain alkyl group having 1 to 6 carbon atoms.

Furthermore, introducing the liquid metal-based organic substance into the region from which the organic binder has been removed may be performed by immersing the metal base material having the coating layer, from which the organic binder has been removed, in the liquid metal-based organic substance. Suitably the immersion may be performed for example for 1 second to 10 minutes.

In addition, the second heat treatment may be performed for example at 250° C. to 900° C. for 10 seconds to 24 hours in a vacuum atmosphere.

According to the metal separator and the method of manufacturing the same of the present disclosure, not only can the electrical conductivity and corrosion resistance be excellent, but the adhesion of the coating layer can also be excellent.

### BRIEF DESCRIPTION OF THE DRAWINGS

FIG. 1 is a diagram showing, by way of example, a metal separator in accordance with one embodiment of the present disclosure;

FIG. 2 is a diagram showing, by way of example, a metal separator that has undergone a coating step in order to describe the coating step in accordance with one embodiment of the present disclosure;

FIG. 3 is a diagram showing, by way of example, a metal separator that has undergone a first heat treatment step in order to describe the first heat treatment step in accordance with one embodiment of the present disclosure;

FIG. 4 is a diagram showing, by way of example, a metal separator that has undergone a second heat treatment step in order to describe the second heat treatment step in accordance with one embodiment of the present disclosure;

FIG. 5 is a 10,000× magnification image obtained by capturing the surface of a metal separator that has undergone a coating step in Embodiment 1 with a scanning electron microscope;

FIG. 6 is a 10,000× magnification image obtained by capturing the surface of a metal separator that has undergone a first heat treatment step in Embodiment 1 with a scanning electron microscope; and

FIG. 7 is a 10,000× magnification image obtained by capturing the surface of a metal separator that has undergone a second heat treatment step in Embodiment 1 with a scanning electron microscope.

### DETAILED DESCRIPTION

Hereinafter, a metal separator of the present disclosure will be described with reference to the accompanying drawings, the accompanying drawings are illustrative, and the metal separator of the present disclosure is not limited to the accompanying drawings.

FIG. 1 is a diagram showing, by way of example, a metal separator in accordance with one embodiment of the present disclosure. As shown in FIG. 1, the metal separator 100 of the present disclosure includes a metal base material 110 and a coating layer 120. According to the metal separator 100 of the present disclosure, not only can the electrical conductivity and corrosion resistance be excellent, but the adhesion of the coating layer 120 can also be excellent. In the present specification, the term ┌adhesion of the coating layer┘ means the force with which the coating layer adheres to the metal base material.

The metal base material 110 is a metal material used in a metal separator for fuel cells. The type of the metal base material 110 is not particularly limited, and any metal base material used in a metal separator for fuel cells can be used without limitation. For example, a base material made of titanium, aluminum, magnesium, copper, stainless steel, or an alloy thereof may be used as the metal base material 110. Specifically, a SUS 300 series steel, which is stainless steel, may be used as the metal base material 110. The metal separator 100 can have excellent electrical conductivity by including the metal base material 110 described above.

The coating layer 120 is a layer to be coated on the surface of the metal base material 110, and is formed on the surface of the metal base material 110 and contains a conductive filler 121 and an inorganic polymer 122. By being formed on the surface of the metal base material 110, the coating layer 120 can not only improve the corrosion resistance of the metal base material 110 but also enhance the adhesion of the coating layer 120. In the present specification, the term ┌surface┘, refers to an outer surface located on one side, both sides, or all sides of the metal base material.

The conductive filler 121 is a substance having electrical conductivity. For example, the conductive filler 121 may include one or more selected from carbon black, carbon nanotubes, graphene, and carbon fibers. By including the conductive filler 121 in the coating layer 120, the electrical conductivity of the metal separator 100 can be improved.

In one example, the conductive filler 121 may have a particle diameter of 10 nm to 70 nm. Specifically, the particle diameter of the conductive filler 121 may have a lower limit of 20 nm or more or 30 nm or more, and an upper limit of 60 nm or less, 50 nm or less, or 40 nm or less. By having the particle diameter described above, the conductive filler 121 can improve the electrical conductivity.

The inorganic polymer 122 is a polymer having an inorganic substance other than carbon as a backbone. For example, the inorganic polymer 122 may be a polymer containing a bond between a transition metal element of Group IVB and an oxygen atom. Specifically, the transition metal element of Group IVB may be an element of titanium (Ti), zirconium (Zr), hafnium (Hf), or rutherfordium (Rf). That is, the inorganic polymer 122 may be a titanium sol-gel, a zirconium sol-gel, a hafnium sol-gel, or a rutherfordium sol-gel. By containing the inorganic polymer 122 in the coating layer 120, not only can the electrical conductivity and corrosion resistance of the metal separator 100 be excellent, but the adhesion of the coating layer 120 can also be excellent.

In one example, the inorganic polymer 122 may be contained in the coating layer 110 at 0.01 to 50 parts by weight relative to 100 parts by weight of the conductive filler 121. Specifically, the inorganic polymer 122 may be contained in the coating layer 110 at 0.05 to 40 parts by weight or 0.1 to 30 parts by weight relative to 100 parts by weight of the conductive filler 121. By containing the inorganic polymer 122 in the coating layer 110 in the content described above, not only can the electrical conductivity and corrosion resistance of the metal separator 100 be excellent, but the adhesion of the coating layer 120 can also be excellent.

In another example, the coating layer 120 may have a thickness of 10 nm to 5000 nm. Specifically, the thickness of the coating layer 120 may have an upper limit of 4000 nm or less, 3000 nm or less, 2000 nm or less, or 1000 nm or less. The coating layer 120 can be stabilized without loss of electrical conductivity by having the thickness range described above. In contrast, if the coating layer 120 exceeds the thickness range described above, many pores may be formed inside, thereby causing many defects, which may in turn deteriorate the electrical conductivity and corrosion resistance.

In addition, the coating layer 120 may have a contact resistance of 1 mΩ·cm² to 20 mΩ·cm². Specifically, the contact resistance of the coating layer 120 may have an upper limit of 15 mΩ·cm² or less, or 10 mΩ·cm² or less. As the coating layer 120 has the contact resistance described above, the electrical conductivity of the metal separator 100 can be excellent.

In addition, the coating layer 120 may have a corrosion current of 0.1 μA/cm² to 10 μA/cm². Specifically, the upper limit of the corrosion current of the coating layer 120 may be 9 μA/cm² or less, 8 μA/cm² or less, or 7 μA/cm² or less. As the coating layer 120 has the corrosion current described above, the corrosion resistance of the metal separator 100 can be excellent.

The present disclosure further relates to a method of manufacturing a metal separator. The method of manufacturing a metal separator relates to a method of manufacturing the metal separator described above, and specific details of a metal separator described below will be omitted as the content described in the metal separator above can be applied in the same manner.

In one aspect, the method of manufacturing a metal separator of the present disclosure includes a mixing step, a coating step, a first heat treatment step, and a second heat treatment step. According to the method of manufacturing a metal separator of the present disclosure, not only can the electrical conductivity and corrosion resistance be excellent, but the adhesion of the coating layer can also be excellent.

In one aspect, the mixing step is a step of producing a coating mixture for coating the surface of the metal base material, and is performed by mixing a conductive filler and an organic binder. That is, the conductive filler can be present in a dispersed state in the organic binder by the mixing step.

In one example, the conductive filler may be contained in the coating mixture at 40 to 600 parts by weight relative to 100 parts by weight of the organic binder. Specifically, the conductive filler may be contained in the coating mixture at 60 to 540 parts by weight, 80 to 480 parts by weight, or 100 to 420 parts by weight relative to 100 parts by weight of the organic binder. By having the conductive filler contained in the coating mixture in the content described above, the electrical conductivity of the metal separator can be excellent. Further, conversely, the organic binder may be contained in the coating mixture at 16 to 250 parts by weight relative to 100 parts by weight of the conductive filler. Specifically, the organic binder may be contained in the coating mixture at 18 to 167 parts by weight, 20 to 125 parts by weight, or 23 to 100 parts by weight relative to 100 parts by weight of the conductive filler. By having the organic binder contained in the coating composition in the content described above, the conductive filler can be coated on the surface of the metal base material, which can in turn improve the corrosion resistance of the metal separator.

As the type of the organic binder, a polymer binder that is thermally decomposed at a temperature of 300° C. or higher may be used. For example, the organic binder may include an acryl-based resin, a modified alkyd-based resin, a melanin-based resin, or a mixture thereof. Specifically, a phenol-modified alkyd resin may be used as the modified alkyd-based resin. By containing a polymer binder of the type described above that is thermally decomposed at the temperature described above, the organic binder can be removed in the first heat treatment step described below.

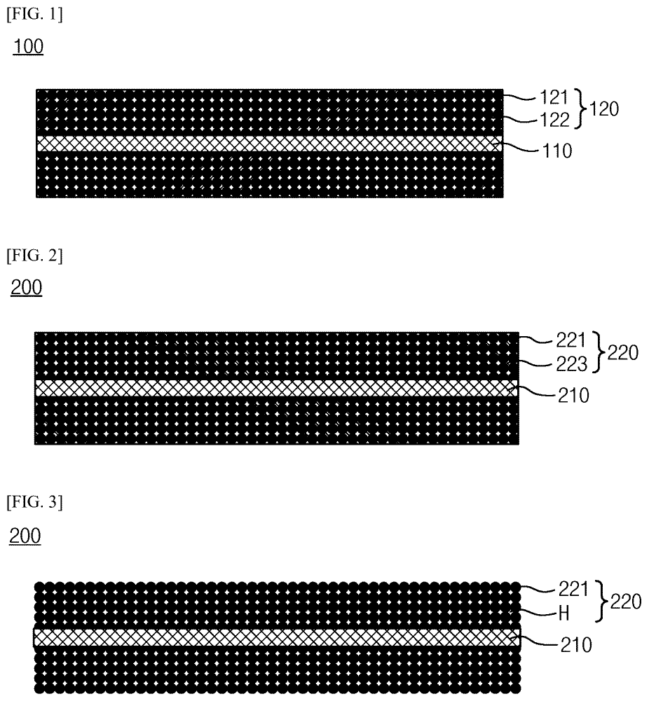

FIG. 2 is a diagram showing, by way of example, a metal separator that has undergone the coating step in order to describe the coating step in accordance with one embodiment of the present disclosure. As shown in FIG. 2, the coating step is a step of forming a coating layer 220 on the surface of a metal base material 210 with the coating mixture produced in the mixing step, and is performed by coating the surface of the metal base material 210 with the coating mixture and subjecting it to temporary drying. By including the coating step in the method of manufacturing a metal separator, a conductive filler 221 can be coated on the surface of the metal base material 210 by the organic binder 223.

A spraying method, physical vapor deposition, or the like may be used as the method of coating the coating mixture.

In addition, the coating thickness when coating the coating mixture may be 0.01 μm to 20 μm, and specifically, 0.02 μm to 18 μm, 0.03 μm to 15 μm, 0.04 μm to 13 μm, or 0.05 μm to 10 μm. By coating the coating mixture at the coating thickness described above when coating, the corrosion resistance of the metal separator can be improved.

The temporary drying refers to tack-free drying in which the coating mixture is dried to the extent that it does not stick to other devices or hands, and may be performed at a temperature of 80°° C. to 200° C. for 10 seconds to 60 minutes. Specifically, the temporary drying may be performed at a temperature of 85° C. to 200° C., 90° C. to 200° C., 95° C. to 200° C., or 100° C. to 200° C. for 20 seconds to 45 minutes or 30 seconds to 30 minutes. In this case, the temporary drying may be performed in an oven.

FIG. 3 is a diagram showing, by way of example, a metal separator that has undergone the first heat treatment step in order to describe the first heat treatment step in accordance with one embodiment of the present disclosure. As shown in FIG. 3, the first heat treatment step is a step of performing heat treatment to remove the organic binder in the coating layer 220, and is performed by subjecting the temporarily dried coating layer 220 to a first heat treatment. By performing the first heat treatment step in the method of manufacturing a metal separator, the organic binder in the coating layer 220 can be thermally decomposed and removed, and thus a region H from which the organic binder in the coating layer 220 has been removed can be formed.

In one example, the first heat treatment may be performed at 250° C. to 900° C. for 10 seconds to 24 hours under a pressure of 0.05 Pa to 0.5 Pa. Specifically, the first heat treatment may be performed at 300° C. to 800° C., 400° C. to 700° C., or 500° C. to 600° C. for 20 seconds to 19 hours, 30 seconds to 14 hours, 40 seconds to 9 hours, 50 seconds to 4 hours, 1 minute to 1 hour, 3 to 50 minutes, 5 to 40 minutes, 7 to 30 minutes, 9 to 20 minutes, or 10 to 15 minutes under a pressure of 0.4 Pa or less, 0.3 Pa or less, 0.2 Pa or less, or 0.1 Pa or less. By performing the first heat treatment under the conditions described above, the organic binder in the coating layer 220 can be completely removed. In this case, the pressure refers to the partial pressure of oxygen in a low oxygen atmosphere. By performing the first heat treatment in the low oxygen atmosphere described above, oxidation of the metal base material can be precluded, thereby preventing an oxide layer from being formed on the metal base material.

In another example, the method of manufacturing a metal separator may further include a thickness adjustment step. The thickness adjustment step is a step of adjusting the thickness of the coating layer from which the organic binder has been removed through the first heat treatment step, and may be performed to reduce the thickness of the coating layer from which the organic binder has been removed. Specifically, the thickness adjustment step may be performed by repeating an attaching and detaching process on the surface of the coating layer from which the organic binder has been removed with a tape having an adhesive formed on one side. By further including the thickness adjustment step in the method of manufacturing a metal separator, the thickness of the coating layer from which the organic binder has been removed can be reduced to a desired thickness, which can in turn improve the electrical conductivity.

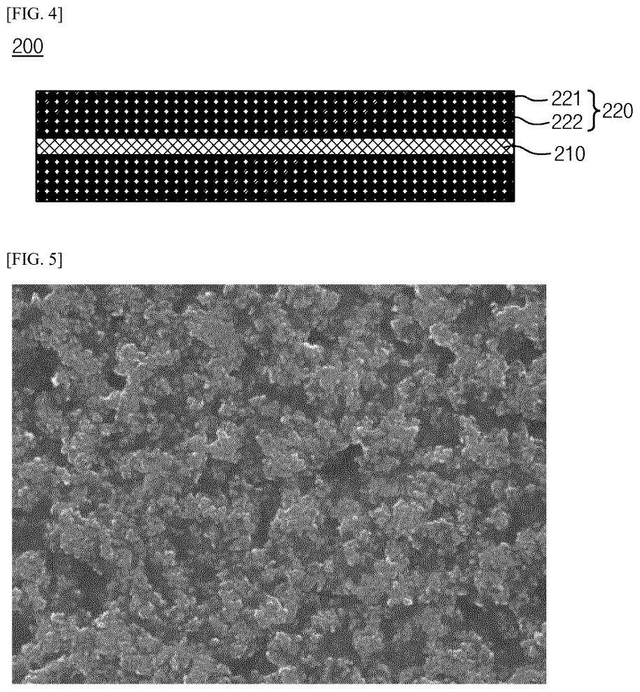

FIG. 4 is a diagram showing, by way of example, a metal separator that has undergone the second heat treatment step in order to describe the second heat treatment step in accordance with one embodiment of the present disclosure. As shown in FIG. 4, the second heat treatment step is a step of introducing a liquid metal-based organic substance into the region of the coating layer from which the organic binder has been removed through the first heat treatment, and then performing heat treatment to gel the liquid metal-based organic substance into an inorganic polymer 222. By performing the second heat treatment step in the method of manufacturing a metal separator, the inorganic polymer 222 can be formed in the region of the coating layer from which the organic binder has been removed, resulting in electrical conductivity and corrosion resistance being excellent as well as the adhesion of the coating layer 220 being excellent.

The liquid metal-based organic substance may be present in a state where a metal-based organic substance represented by Chemical Formula 1 below is dispersed in a liquid dispersion medium.

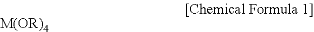

In Chemical Formula 1 above, M is a transition metal element of Group IVB, and R is a straight-chain or branched-chain alkyl group having 1 to 6 carbon atoms.

Specifically, the transition metal element of Group IVB may be for example an element of titanium (Ti), zirconium (Zr), hafnium (Hf), or rutherfordium (Rf). By containing the transition metal element of Group IVB described above in the liquid metal-based organic substance, the conductivity of the metal separator 200 can be excellent.

In addition, R may be a straight-chain or branched-chain alkyl group having 1 to 6 carbon atoms, and specifically, may be a straight-chain or branched-chain alkyl group having 1 to 5 carbon atoms, 1 to 4 carbon atoms, or 1 to 3 carbon atoms. Specific examples of R may be a straight-chain alkyl group consisting of ethyl, methyl, propyl, butyl, pentyl, or hexyl, or a branched-chain alkyl group consisting of n-propyl, isopropyl, n-butyl, isobutyl, sec-butyl, tert-butyl, 1-methyl-butyl, 1-ethyl-butyl, n-pentyl, isopentyl, neopentyl, tert-pentyl, n-hexyl, 1-methylpentyl, 2-methylpentyl, or 4-methyl-2-pentyl.

For example, the metal-based organic substance of Chemical Formula 1 above may be titanium tetraisopropoxide (Ti(OCH(CH₃)₂)₄), zirconium tetraisopropoxide (Zr(OCH(CH₃)₂)₄), titanium tetraethoxide (Ti(OC₂H₅)₄), or zirconium tetraethoxide (Zr(OC₂H₅)₄).

In another example, the metal-based organic substance may be charged with an inorganic acid. For example, nitric acid (HNO₃), sulfuric acid (H₂SO₄), hydrochloric acid (HCl), phosphoric acid (H₃PO₄), perchloric acid (HClO₄), hypochlorous acid (HClO), hydrofluoric acid (HF), acetic acid (CH₃COOH), or the like may be used as the inorganic acid. By having the metal-based organic substance charged with the inorganic acid described above, the metal contained in the metal-based organic substance can be stabilized.

Any dispersion medium known in the art may be used without particular limitation as the type of the dispersion medium. By using the type described above as the dispersion medium, an inorganic oligomer can be formed.

In one example, the liquid metal-based organic substance may have a solid content of 1% to 5%, specifically, 1.5% to 4% or 2% to 3%. By having the solid content of the liquid metal-based organic substance satisfy the range described above, not only can the electrical conductivity and corrosion resistance be excellent, but the adhesion of the coating layer can also be excellent.

In addition, the liquid metal-based organic substance may have a pH of greater than 0 to 4, specifically, 0.5 to 3 or 1 to 2. By having the pH of the liquid metal-based organic substance satisfy the range described above, the metal contained in the metal-based organic substance can be stabilized.

In one example, introducing the liquid metal-based organic substance into the region from which the organic binder has been removed may be performed by immersing the metal base material having the coating layer, from which the organic binder has been removed, in the liquid metal-based organic substance.

For example, introducing the liquid metal-based organic substance into the region from which the organic binder has been removed may be performed by immersing the metal base material having the coating layer, from which the organic binder has been removed, in the liquid metal-based organic substance. In this case, the immersion may be performed for 1 second to 10 minutes. Specifically, the immersion may be performed for 1 second to 8 minutes or 1 second to 5 minutes. By performing the immersion for the time described above, the liquid metal-based organic substance can be introduced into all regions of the coating layer from which the organic binder has been removed.

Further, the second heat treatment may be performed in a vacuum atmosphere at 250° C. to 900° C. for 10 seconds to 24 hours. Specifically, the second heat treatment may be performed in a vacuum atmosphere at 300° C. to 800° C., 400° C. to 700° C., or 500° C. to 600° C. for 20 seconds to 19 hours, 30 seconds to 14 hours, 40 seconds to 9 hours, 50 seconds to 4 hours, 1 minute to 1 hour, 3 to 50 minutes, 5 to 40 minutes, 7 to 30 minutes, 9 to 20 minutes, or 10 to 15 minutes. By performing the second heat treatment under the conditions described above, the liquid metal-based organic substance introduced into the region of the coating layer from which the organic binder has been removed can be gelled into the inorganic polymer 222. The term ┌vacuum atmosphere┘ in the present specification refers to a working environment having a vacuum state. For example, the pressure of the vacuum atmosphere may be 0.0001 Pa to 0.01 Pa. By performing the second heat treatment in the vacuum atmosphere described above, the liquid metal-based organic substance can be gelled into the inorganic polymer 222, and the electrical conductivity can be improved by twisting the lattice of the titanium dioxide oxide film that can be generated during the gelation process.

In the following, the present disclosure will be described in greater detail through embodiments according to the present disclosure and comparative examples not according to the present disclosure, but the scope of the present disclosure is not limited by the embodiments presented below.

### Embodiment 1

### Production of Coating Mixture

Carbon black having a particle diameter of 50 nm was used as a conductive filler, an acrylic resin was used as an organic binder, and the conductive filler and the organic binder were diluted in an isopropyl alcohol organic solvent in a ratio of 5 to 5, thereby producing a coating mixture.

### Manufacturing of Metal Separator

A titanium metal base material (Grade 1) was prepared, and the coating mixture produced in Embodiment 1 above was coated on the surface of the titanium metal base material in a thickness of 1 μm by roll-coating. Then, the metal base material coated with the coating mixture was placed in an oven and was subjected to temporary drying at a temperature of 150°° C. for 5 minutes, thereby forming a coating layer on the surface of the metal base material. At this time, the surface of the metal base material on which the coating layer was formed was photographed, and the result is shown in FIG. 5.

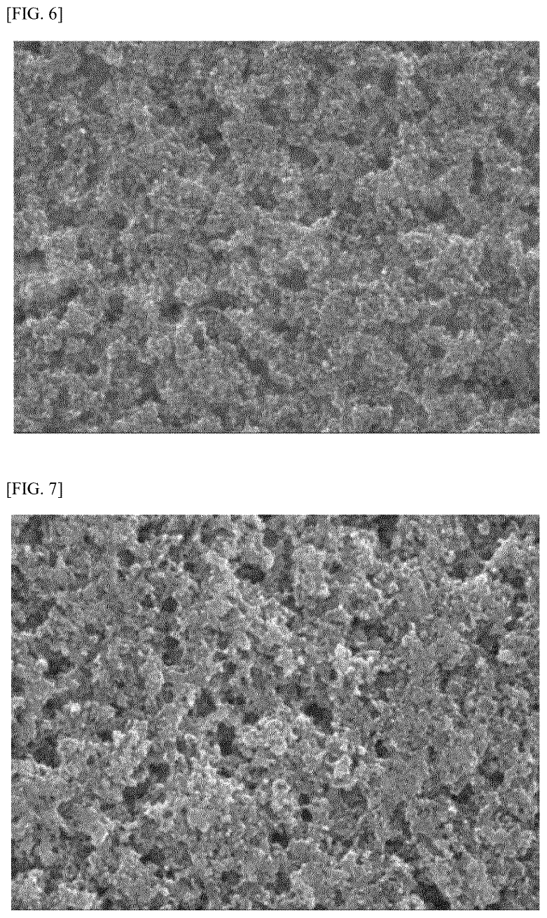

Then, the metal base material on which the coating layer was formed was subjected to a first heat treatment of heating at 600° C. for 10 minutes in a low oxygen atmosphere of 0.1 Pa, thereby removing the organic binder in the coating layer. At this time, the coating layer from which the organic binder was removed was photographed, and the result is shown in FIG. 6.

Then, the metal base material having the coating layer, from which the organic binder was removed, was immersed for 5 minutes in a liquid metal-based organic substance having a solid content of 1% as titanium tetraisopropoxide was dispersed in a dispersion medium and a pH of 2 as charged with nitric acid, thereby causing the liquid metal-based organic substance to be introduced into the region from which the organic binder was removed. Then, the metal base material on which the coating layer into which the liquid metal-based organic substance was introduced was formed was subjected to a second heat treatment of heating at 600° C. for 10 minutes in a vacuum atmosphere of 0.01 Pa, which caused the liquid metal-based organic substance to be gelled into TiO polymer, which is an inorganic polymer, thereby manufacturing a metal separator having a coating layer of 1 μm thickness formed on the surface of the metal base material. At this time, the coating layer formed on the surface of the metal base material of the metal separator was photographed, and the result is shown in FIG. 7.

### Embodiment 2

### Production of Coating Mixture

A coating mixture was produced in the same manner as in Embodiment 1 above, except that the ratio of the conductive filler to the organic binder was changed to 7:3.

### Manufacturing of Metal Separator

A metal separator was manufactured in the same manner as in Embodiment 1 above, except that the coating mixture produced in Embodiment 2 above was used.

### Embodiment 3

### Production of Coating Mixture

A coating mixture was produced in the same manner as in Embodiment 1 above, except that the ratio of the conductive filler to the organic binder was changed to 8:2.

### Manufacturing of Metal Separator

A metal separator was manufactured in the same manner as in Embodiment 1 above, except that the coating mixture produced in Embodiment 3 above was used.

### Embodiment 4

### Production of Coating Mixture

A coating mixture was produced in the same manner as in Embodiment 1 above, except that the ratio of the conductive filler to the organic binder was changed to 6:4.

### Manufacturing of Metal Separator

A metal separator was manufactured in the same manner as in Embodiment 1 above, except that the coating mixture produced in Embodiment 4 above was used.

### Embodiment 5

### Production of Coating Mixture

Carbon black having a particle diameter of 50 nm was used as a conductive filler, a phenol-modified alkyd resin was used as an organic binder, and the conductive filler and the organic binder were diluted in an isopropyl alcohol organic solvent in a ratio of 6 to 4, thereby producing a coating mixture.

### Manufacturing of Metal Separator

A metal separator was manufactured in the same manner as in Embodiment 1 above, except that the coating mixture produced in Embodiment 5 above was used.

### Comparative Example 1

### Production of Coating Mixture

A coating mixture was produced in the same manner as in Embodiment 1.

### Manufacturing of Metal Separator

A titanium metal base material (Grade 1) was prepared, and the coating mixture produced in Comparative Example 1 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, and thus, a coating layer was formed on the surface of the metal base material, thereby manufacturing a metal separator.

### Comparative Example 2

### Production of Coating Mixture

A coating mixture was produced in the same manner as in Embodiment 1.

### Manufacturing of Metal Separator

A titanium metal base material (Grade 1) was prepared, and the coating mixture produced in Comparative Example 2 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, thereby forming a coating layer on the surface of the metal base material.

Then, the metal base material on which the coating layer was formed was subjected to a first heat treatment of heating at 600° C. for 10 minutes in a low oxygen atmosphere of 0.1 Pa, and thus, the organic binder in the coating layer was removed, thereby manufacturing a metal separator.

### Comparative Example 3

### Production of Coating Mixture

A coating mixture was produced in the same manner as in Embodiment 2.

### Manufacturing of Metal Separator

A titanium metal base material (Grade 1) was prepared, and the coating mixture produced in Comparative Example 3 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, and thus, a coating layer was formed on the surface of the metal base material, thereby manufacturing a metal separator.

### Comparative Example 4

### Production of Coating Mixture

A coating mixture was produced in the same manner as in Embodiment 2.

### Manufacturing of Metal Separator

A titanium metal base material (Grade 1) was prepared, and the coating mixture produced in Comparative Example 4 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, thereby forming a coating layer on the surface of the metal base material.

Then, the metal base material on which the coating layer was formed was subjected to a first heat treatment of heating at 600° C. for 10 minutes in a low oxygen atmosphere of 0.1 Pa, and thus, the organic binder in the coating layer was removed, thereby manufacturing a metal separator.

### Comparative Example 5

### Production of Coating Mixture

A coating mixture was produced in the same manner as in Embodiment 3.

### Manufacturing of Metal Separator

A titanium metal base material (Grade 1) was prepared, and the coating mixture produced in Comparative Example 5 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, and thus, a coating layer was formed on the surface of the metal base material, thereby manufacturing a metal separator.

### Comparative Example 6

### Production of Coating Mixture

A coating mixture was produced in the same manner as in Embodiment 3.

### Manufacturing of Metal Separator

A titanium metal base material (Grade 1) was prepared, and the coating mixture produced in Comparative Example 6 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, thereby forming a coating layer on the surface of the metal base material.

Then, the metal base material on which the coating layer was formed was subjected to a first heat treatment of heating at 600° C. for 10 minutes in a low oxygen atmosphere of 0.1 Pa, and thus, the organic binder in the coating layer was removed, thereby manufacturing a metal separator.

### Comparative Example 7

### Production of Coating Mixture

A coating mixture was produced in the same manner as in Embodiment 4.

### Manufacturing of Metal Separator

A titanium metal base material (Grade 1) was prepared, and the coating mixture produced in Comparative Example 7 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, and thus, a coating layer was formed on the surface of the metal base material, thereby manufacturing a metal separator.

### Comparative Example 8

### Production of Coating Mixture

A coating mixture was produced in the same manner as in Embodiment 4.

### Manufacturing of Metal Separator

A titanium metal base material (Grade 1) was prepared, and the coating mixture produced in Comparative Example 8 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, thereby forming a coating layer on the surface of the metal base material.

Then, the metal base material on which the coating layer was formed was subjected to a first heat treatment of heating at 600° C. for 10 minutes in a low oxygen atmosphere of 0.1 Pa, and thus, the organic binder in the coating layer was removed, thereby manufacturing a metal separator.

### Comparative Example 9

### Production of Coating Mixture

A coating mixture was produced in the same manner as in Embodiment 5.

### Manufacturing of Metal Separator

A titanium metal base material (Grade 1) was prepared, and the coating mixture produced in Comparative Example 9 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, and thus, a coating layer was formed on the surface of the metal base material, thereby manufacturing a metal separator.

### Comparative Example 10

### Production of Coating Mixture

A coating mixture was produced in the same manner as in Embodiment 5.

### Manufacturing of Metal Separator

A titanium metal base material (Grade 1) was prepared, and the coating mixture produced in Comparative Example 10 above was coated on the surface of the titanium metal base material in a thickness of 1 μm by roll-coating. Then, the metal base material coated with the coating mixture was placed in an oven and was subjected to temporary drying at a temperature of 150° C. for 5 minutes, thereby forming a coating layer on the surface of the metal base material.

Then, the metal base material on which the coating layer was formed was subjected to a first heat treatment of heating at 600° C. for 10 minutes in a low oxygen atmosphere of 0.1 Pa, and thus, the organic binder in the coating layer was removed, thereby manufacturing a metal separator.

### Experimental Example 1. Evaluation of Contact Resistance

The contact resistance of the metal separators manufactured in the embodiments and comparative examples was measured with the IM6 instrument of Zahner by using the four-wire current-voltage measurement principle, and the results are shown in Table 1 below. Specifically, the contact resistance measurement method was performed in the range of 10 kHz to 10 mHz in the constant current mode by setting a DC current of 5 A, with a measurement area of an amplitude of 0.5 A and an electrode area of 25 cm².

### Experimental Example 2. Evaluation of Corrosion Current

The corrosion current of the metal separators manufactured in the embodiments and comparative examples was measured with an EG&G 273A measurement instrument under a simulated environment of a PEFC (Polymer Electrolyte Fuel Cell), and the results are shown in Table 1 below. Specifically, the corrosion current was measured in the range of OCP (open circuit potential) −0.25 V_{SCE} to 1.2 V_{SCE} after placing the metal separators manufactured in the embodiments and comparative examples in a 0.1 N H₂SO₄+2 ppm HF solution at 80° C. and then bubbling them with nitrogen (N₂) for 1 hour.

### Experimental Example 3. Evaluation of Adhesion

In order to evaluate the adhesion of the coating layer included in the metal separators manufactured in the embodiments and comparative examples, a tape was attached to the coating layer and then peeled off at 90°, thereby checking whether the coating layer was peeled off onto the tape, and the results are shown in Table 1 below.

TABLE 1

| | Contact | Corrosion | |
|---|---|---|---|
| | resistance | current | |
| | (mΩ · cm²) | (μA/cm²) | Adhesion |
| Embodiment 1 | 6.4 | 4.9 | 4 |
| Embodiment 2 | 6.0 | 6.3 | 4 |
| Embodiment 3 | 6.3 | 5.0 | 4 |
| Embodiment 4 | 6.3 | 6.5 | 4 |
| Embodiment 5 | 6.5 | 6.0 | 4 |
| Comparative Example 1 | 812.3 | 2.3 | 4 |
| Comparative Example 2 | 7.4 | 1.8 | 2 |
| Comparative Example 3 | 29.7 | 5.6 | 4 |
| Comparative Example 4 | 7.3 | 4.6 | 2 |
| Comparative Example 5 | 35.6 | 6.9 | 4 |
| Comparative Example 6 | 8.4 | 1.6 | 2 |
| Comparative Example 7 | 217.7 | 27.6 | 4 |
| Comparative Example 8 | 6.5 | 8.3 | 2 |
| Comparative Example 9 | 77.5 | 2.8 | 4 |
| Comparative Example 10 | 6.0 | 7.0 | 2 |

1: Very poor adhesion
2: Slightly poor adhesion
3: Slightly good adhesion
4: Very good adhesion

As shown in Table 1 above, it was confirmed not only that the metal separators manufactured in Embodiments 1 to 5 above had excellent electrical conductivity and corrosion resistance by having a contact resistance of 20 mΩ·cm² or less and a corrosion current of 10 μA/cm² or less, but also that the adhesion of the coating layer was excellent. In contrast, it was confirmed that the metal separators manufactured in Comparative Examples 1, 3, 5, and 9 above had excellent corrosion resistance by having a corrosion current of 10 μA/cm² or less and excellent adhesion of the coating layer, but had a low electrical conductivity by having a contact resistance of greater than 20 mΩ·cm².

In addition, it was confirmed that the metal separators manufactured in Comparative Examples 2, 4, 6, 8, and 10 above had excellent electrical conductivity and corrosion resistance by having a contact resistance of 20 mΩ·cm² or less and a corrosion current of 10 μA/cm² or less, but had a lower adhesion of the coating layer than that of the metal separators manufactured in Embodiments 1 to 5 above.

Further, it was confirmed that the metal separator manufactured in Comparative Example 7 above had excellent adhesion of the coating layer, but had low electrical conductivity and corrosion resistance by having a contact resistance of greater than 20 mΩ·cm² and a corrosion current of greater than 10 μA/cm².

In other words, it was confirmed that the metal separators manufactured in Embodiments 1 to 5 above were able to secure excellent electrical conductivity, corrosion resistance, and adhesion of the coating layer simultaneously.

### DESCRIPTION OF REFERENCE NUMERALS

100, 200: Metal separator
110, 210: Metal base material
120, 220: Coating layer
121, 221: Conductive filler
122, 222: Inorganic polymer
223: Organic binder
H: Region of the coating layer from which the organic binder has been removed

What is claimed:

1. A metal separator comprising:
a metal base material; and
a coating layer formed on a surface of the metal base material and containing a conductive filler and an inorganic polymer.

2. The metal separator of claim 1, wherein the conductive filler comprises one or more selected from carbon black, carbon nanotubes, graphene, and carbon fibers.

3. The metal separator of claim 1, wherein the inorganic polymer is a polymer containing a bond between a transition metal element of Group IVB and an oxygen atom.

4. The metal separator of claim 1, wherein the inorganic polymer is contained in the coating layer at 0.01 to 50 parts by weight relative to 100 parts by weight of the conductive filler.

5. The metal separator of claim 1, wherein the coating layer has a thickness of 10 nm to 5000 nm.

6. The metal separator of claim 1, wherein the coating layer has a contact resistance of 1 mΩ·cm² to 20 mΩ·cm².

7. The metal separator of claim 1, wherein the coating layer has a corrosion current of 0.1 μA/cm² to 10 μA/cm².

8. A method of manufacturing a metal separator comprising a metal base material and a coating layer formed on a surface of the metal base material and containing a conductive filler and an inorganic polymer, the method comprising:
mixing a conductive filler and an organic binder and producing a coating mixture;
coating the surface of the metal base material with the coating mixture, performing temporary drying, and forming a coating layer;
performing a first heat treatment on the temporarily dried coating layer and removing the organic binder in the coating layer; and
introducing a liquid metal-based organic substance into a region from which the organic binder has been removed, then performing a second heat treatment, and gelling the liquid metal-based organic substance into an inorganic polymer.

9. The method of claim 8, wherein the conductive filler is contained in the coating mixture at 40 to 600 parts by weight relative to 100 parts by weight of the organic binder.

10. The method of claim 8, wherein the temporary drying is performed at a temperature of 80° C. to 200° C. for 10 seconds to 60 minutes.

11. The method of claim 8, wherein the first heat treatment is performed at 250° C. to 900° C. for 10 seconds to 24 hours under a pressure of 0.05 Pa to 0.5 Pa.

12. The method of claim 8, further comprising:
a thickness adjustment step of the coating layer for reducing a thickness of the coating layer from which the organic binder has been removed.

13. The method of claim 8, wherein the liquid metal-based organic substance is present in a state where a metal-based organic substance represented by Chemical Formula 1 below is dispersed in a liquid dispersion medium: 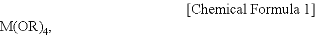
in said Chemical Formula 1, M is a transition metal element of Group IVB, and R is a straight-chain or branched-chain alkyl group having 1 to 6 carbon atoms.

14. The method of claim 8, wherein introducing the liquid metal-based organic substance into the region from which the organic binder has been removed is performed by immersing the metal base material having the coating layer, from which the organic binder has been removed, in the liquid metal-based organic substance, and the immersion is performed for 1 second to 10 minutes.

15. The method of claim 8, wherein the second heat treatment is performed at 250° C. to 900° C. for 10 seconds to 24 hours in a vacuum atmosphere.
